(19) United States
(12) Patent Application Publication
(10) Pub. No.: US 2015/0208264 A1
(43) Pub. Date: Jul. 23, 2015

(54) METHOD AND APPARATUS FOR ADAPTING MINIMISATION OF DRIVE TESTING REPORTS TO OPERATIONAL MODE OF USER EQUIPMENT USING ASSISTANCE INFORMATION

(71) Applicants: Jussi-Pekka Koskinen, Oulu (FI); Ilkka Antero Keskitalo, Oulu (FI); Jorma Kaikkonen, Oulu (FI)

(72) Inventors: Jussi-Pekka Koskinen, Oulu (FI); Ilkka Antero Keskitalo, Oulu (FI); Jorma Kaikkonen, Oulu (FI)

(73) Assignee: Nokia Corporation, Espoo (FI)

(21) Appl. No.: 14/410,873

(22) PCT Filed: Jul. 3, 2012
(86) PCT No.: PCT/US2012/045455

§ 371 Date: Dec. 23, 2014

(51) Int. Cl. H04W 24/10; H04W 52/02

(52) U.S. Cl. CPC H04W 24/10; H04W 52/0212

(57) ABSTRACT

In one aspect there is provided a method. The method may include sending, by a user equipment, a minimization of drive testing report to a network; and sending, by the user equipment, assistance information to the network for a minimization of drive testing function at the network, wherein the assistance information includes at least one of a mobility information and a user equipment indication representative of a preference for power saving at the user equipment. Related apparatus, systems, methods, and articles are also described.

### FIELD

The subject matter described herein relates to wireless communications.

### BACKGROUND

Operators test their networks to identify coverage holes (also referred to as dead zones) or weak coverage areas in their networks. The drive test is a manual process that literally includes driving in a vehicle to collect power, location, and other measurements to build coverage maps and identify potential coverage holes or other issues in the radio network. Once an operator identifies a coverage hole, the operator may attempt to enhance existing coverage to address the hole by, for example, adding a base station, increasing power, changing the orientation of base station antennas, and the like.

Operators have typically performed manual testing and verification of cellular radio networks by performing drive testing which includes specific measurements to collect data and to verify the operation of the network. Minimization of drive testing (MDT) may, however, provide a framework, which includes numerous standards seeking to overcome the costs and environmental impact related to traditional, manual drive testing. Instead of manual drive testing, the network and/or the user equipment collect measurements to allow MDT and thus perform testing of the network, such as network coverage, capacity optimization, optimization of mobility parameters, quality of service verification, and the like. Indeed, numerous standards have been specified to provide a framework for MDT. Examples of standards which can be used in testing user equipment include: (1) 3GPP TS 34.109, V10.1.0 (2011-12), Technical Specification: 3rd Generation Partnership Project; Technical Specification: Group Radio Access Network; Terminal logical test interface; Special conformance testing functions (Release 10); (2) 3GPP TS 37.320, V10.4.0 (2011-12), Technical Specification: 3rd Generation Partnership Project; Technical Specification: Group Radio Access Network; Universal Terrestrial Radio Access (UTRA) and Evolved Universal Terrestrial Radio Access (E-UTRA); Radio measurement collection for Minimization of Drive Tests (MDT); Overall description; Stage 2 (Release 10); (3) 3GPP TS 36.331, V10.4.0 (2011-12), Technical Specification: 3rd Generation Partnership Project; Technical Specification Group Radio Access Network; Evolved Universal Terrestrial Radio Access (E-UTRA); Radio Resource Control (RRC); Protocol specification (Release 10), (4) 3GPP TS 36.355, V10.4.0 (2011-12), Technical Specification: 3rd Generation Partnership Project; Technical Specification Group Radio Access Network; Evolved Universal Terrestrial Radio Access (E-UTRA); LTE Positioning Protocol (LPP) (Release 10); (5) 3GPP TS 36.509, V9.5.0 (2011-09), Technical Specification: 3rd Generation Partnership Project; Technical Specification Group Radio Access Network; Evolved Universal Terrestrial Radio Access (E-UTRA) and Evolved Packet Core (EPC); Special conformance testing functions for User Equipment (UE) (Release 9); (6) 3GPP TS 36.508, V9.7.0 (2011-12), Technical Specification: 3rd Generation Partnership Project; Technical Specification Group Radio Access Network; Evolved Universal Terrestrial Radio Access (E-UTRA) and Evolved Packet Core (EPC); Common test environments for User Equipment (UE) conformance testing (Release 9); and any additions and revisions to these and other standards.

MDT measurement and subsequent reporting may include two modes referred to herein as immediate MDT and logged MDT. MDT reports from the user equipment to the network may be immediate, when the user equipment is in an active, or a connected mode. This immediate reporting corresponds to the normal reporting expectations for radio resource management (RRM). Moreover, the MDT reports sent by the user equipment to the network may be triggered by an event, such as signal level going below a given threshold, periodically triggered by a timer, and the like. In the case of MDT reporting when the user equipment is in an idle mode, in which case immediate MDT reporting is not possible, the user equipment may record (also referred to as log) MDT measurements made by the user equipment and wait until a connection is available between the user equipment and the network in order to send the MDT report. In any case, the network may receive one or more MDT reports to assess the performance of the network, such as network coverage, capacity optimization, optimization of mobility parameters, quality of service verification, and the like.

Operators may also seek to establish self-optimizing networks (SON). For example, SON may allow the wireless access network to provide self-configuration (e.g., a node, such as a base station is automatically configured and implemented in the network), self-optimization (e.g., network parameters can be automatically adjusted), and/or self-healing (e.g., the impact of a failure can be reduced). The Third Generation Partnership Project (3GPP) is considering SON as can be seen by the following: 3GPP TR 36.902, Evolved Universal Terrestrial Radio Access Network (E-UTRAN), Self-configuring and self-optimizing network (SON) use cases and solutions, 3GPP TR 32.821, Telecommunication management, Study of Self-Organizing Networks (SON) related Operations, Administration and Maintenance (OAM) for Home Node B (HNB), 3GPP TS 36.423 Evolved Universal Terrestrial Radio Access Network (E-UTRAN), X2 Application Protocol (X2AP), and the like.

Moreover, networks and user equipment, such as smart phones and the like, are gradually changing the characteristics of mobile traffic. There are increasingly more applications at the user equipment requiring so-called “always-on” connections to a serving application in the network. This trend gives rise to a number of challenges both in the radio access network load as well as in the user equipment. For example, the network may have issues with signaling load and radio resource usage caused by a large number of connected user equipment or these user equipment changing state between connected and the more power/resource efficient idle mode. Moreover, the user equipment including the always-on applications may also generate traffic when unattended. For example, user equipment, such as a smart phone, may include an always-on application, such as a social networking application, a voice over internet protocol (IP) application, a location service application, and the like, that generates traffic even when not in active use. This so-called “background” traffic from these always-on applications may include one or more packets (or bursts of packets) of relatively small size sent intermittently, polling messages between the always-on application and a serving application in the network, keep-alive messages between the always-on application and a serving application in the network, status updates between the always-on application at the user equipment and a serving application in the network, update queries between the always-on application at the user equipment and a serving application in the network, or anything that the application (or operating systems hosting the application) may send to the network, when the user equipment hosting the always-on application is not actively being used by the user.

### SUMMARY

In some example embodiments, there may be provided a method. The method may include sending, by a user equipment, a minimization of drive testing report to a network; and sending, by the user equipment, assistance information to the network for a minimization of drive testing optimization function at the network, wherein the assistance information includes at least one of a mobility information and a user equipment indication representative of a preference for power saving at the user equipment.

In some variations of some of the embodiments disclosed herein, one or more of the following may be included. The user equipment may be configured to send the assistance information for smart phone optimization, wherein the assistance information enables the minimization of drive testing function at the network to adapt based on at least one of a mobility state of the user equipment and a power savings mode of the user equipment. The minimization of drive testing report may comprise at least one of a measurement information, a failure information, and a location information. At least one of the user equipment and the network may associate a measurement result in the minimization of drive testing report with the assistance information. The assistance information and the minimization of drive test report may be sent in a same message or different messages. The minimization of drive testing function may validate a relevance of the assistance information including a mobility and a velocity reported by the network. The minimization of drive testing function at the network may adapt information from the minimization of drive testing report based on the associated assistance information, wherein the adaption includes at least one of a removal of a portion of the information and an adjustment of a weight used to vary the portion of the information.

In some example embodiments, there may be provided a method. The method may include sending, by a user equipment to the network including a self optimizer, a report including failure information; and sending, by the user equipment, assistance information to the network including the self optimizer, wherein the assistance information includes at least one of a mobility information and a user equipment indication representative of a preference for power saving at the user equipment.

In some variations of some of the embodiments disclosed herein, one or more of the following may be included. The user equipment may be configured to send the assistance information for smart phone optimization, and wherein the assistance information enables the self optimizer to adapt based on at least one of a mobility state of the user equipment and a power savings mode of the user equipment. The failure information may include at least one of a radio link failure information and a handover failure information. The self optimizer may determine an adjustment to at least one network parameter based on the assistance information. At least one of the user equipment and the network may associate the report including the failure information with the assistance information. The assistance information and the report may be sent in a same message or different messages.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram of a wireless communication system, in accordance with some example embodiments;

FIG. 2A depicts a process for providing assistance information to the network during MDT processing, in accordance with some example embodiments;

FIG. 2B depicts a process for providing assistance information to the network during SON processing, in accordance with some example embodiments;

FIG. 3 depicts another process for providing assistance information to the network, in accordance with some example embodiments;

FIG. 4 depicts an example of a base station, in accordance with some example embodiments; and

FIG. 5 depicts an example of user equipment, in accordance with some example embodiments.

Like labels are used to refer to same or similar items in the drawings.

### DETAILED DESCRIPTION

In some example embodiments, the user equipment may report information, such as measurement results, minimization of drive testing (MDT) reports, and other data, to the network and further provide the reported information to an operations and maintenance (O&M) node configured to collect and analyze the information including other minimization of drive testing (MDT) data. The MDT reports from the user equipment may include radio measurements results, information about failure events, and location information, when the location information of the user equipment is available at the time of the data collection. User equipment having enhanced features, such as for example smart phone optimization, may also provide assistance information to the network. Smart phone optimization refers to user equipment (and/or the network) optimization to operate with diverse data applications targeted to minimize signaling load and usage of the radio resources while also trying to minimize user equipment power consumption. An example of diverse data applications are always-on applications, which transmit background traffic even when the smart phone is not being used actively by the user. This background traffic may cause frequent idle/connected state transitions, or, when keeping the user equipment in connected state, excessive mobility (e.g., handover) signaling when compared to the amount of data that is transferred through the radio interface. Hence, the network optimization may be considered a trade-off between the signaling due to state transitions and mobility. This trade-off may be considered a function of user equipment mobility (e.g., how often there are mobility events, such as cell changes, occurred with respect to traffic generated by the user equipment, particularly by a smart phone). If the user equipment is kept connected between the traffic bursts, the connection reserves radio resources, such as Physical Uplink Control Channel (PUCCH) resources that may reserve unnecessarily large amounts of radio resources (which may detract from system efficiency). In any case, the user equipment supporting features for smart phone optimization may provide, to the network, assistance information comprising mobility information and/or an indication of a preference for power savings at the user equipment. The addition of assistance information may, in some example embodiments, enhance the network's MDT processing.

Moreover, the user equipment may provide, in some example embodiments, information to a SON function in the network. The SON function may be provided by a single node in the network and/or distributed among a plurality of nodes. In any case, the user equipment may report information, such as failure information, to the SON function. The failure information may represent a failure event, such as a radio link failure or a handover failure. The SON function may use this failure information to optimize network parameters, such as mobility parameters being used in the network, when trying to reach an optimum set of mobility parameter values under various radio circumstances, deployment scenarios, and/or mobility scenarios. Moreover, when the user equipment is configured in accordance with smart phone optimization, the user equipment may report to the network/SON function assistance information that can also be used to enhance the SON function. This assistance information may also include mobility information or an indication of power savings at the user equipment. The addition of assistance information may, in some example embodiments, enhance SON-based processing.

When the assistance information provided by the user equipment includes mobility information, the mobility information may represent the mobility of the user equipment. The mobility information may represent a mobility state, such as low, medium, and high, of the user equipment, a degree of cell changes over a certain period of time (e.g., by keeping track of cell changes that have occurred), a mobility state estimation (MSE) information, location information, and the like. For example, the user equipment can indicate its mobility information (also referred to as mobility state) in a connected state and send the mobility information to the network, although the mobility state may also be estimated by the network as well. The mobility information may also comprise condensed information representative of whether the user equipment is estimating whether it is moving or not. Movement may also be determined based on cell re-selections or cell handovers if such events have or have not happened during a given time period. Further, an indication about the user equipment's movement may be an amount of time the user equipment stayed in a certain cell where a connection is set up. Additionally, a time threshold may be used to assess mobility. For example, if the time a user equipment is in a cell is longer than the threshold, the user equipment may be considered slow moving or stationary, whereas if the time a user equipment is in a cell is less than the threshold the user equipment may be considered highly mobile (i.e., high movement within cells). In addition, user equipment mobility information may represent a current mobility state or a previous (or historic) mobility state, and the mobility information may be sent to the network based on the occurrence of an event, such as a connection set up, radio link failure, an access failure, other specific radio event, and the like, or based on a configuration from the network.

When the assistance information includes a preference for power savings at the user equipment, the preference may, in some example embodiments, be configured as an indication, such as a value, a single bit value representative of a true or a false (e.g., true may represent a preference for power optimization at the user equipment), and the like. For example, when the single bit is sent by the user equipment to the network, the user equipment may set the bit (e.g., to true or false) in accordance with the user equipment preference for power saving.

In some example embodiments, the SON function may process the reported information including the assistance information for mobility and/or user preference for power savings to enable one or more SON functions to adapt network parameters to achieve, for example, a more optimized network behavior and performance. The SON function may be based on the reported information, reports received from the user equipment, radio link failure (RLF) reports used for mobility robustness optimization (MRO) to analyze failure causes, and the like. Moreover, the user equipment's assistance information for mobility may be applied in SON mobility robustness optimization (MRO). In this way, SON can treat the measurement results, RLF reports, and the like, differently based on mobility information (e.g., whether the user equipment is in a high mobility state or a low mobility state). For example, the SON function may adapt network parameters and rules/thresholds based on the user equipment mobility information (e.g., perform separate evaluations of SON or weight inputs to the SON adaptation processes). Moreover, the user equipment may also provide to a target cell the configuration (e.g., parameters and the like) used to determine the mobility state of the user equipment

To illustrate with another example, the SON function performing mobility robustness optimization (MRO) may also consider the user equipment preference for power savings and and/or mobility state. For example, information reported by the user equipment to the SON function may be tagged with an indication of whether the user equipment was in a preference for power savings mode and/or in a high/low mobility state. This tagging may be performed by either the user equipment or by the network. This tagging may allow the SON function to ignore reports from the user equipment sent during, for example, a power saving mode at the user equipment as the measurements made and reported to the network during this power savings mode may not necessarily be optimum (e.g., due to a long discontinuous receive (DRX) cycle and the like). Although non-optimized power savings behavior may not be noticeable to an end-user, the SON function's mobility robustness optimization may, however, not use measurements/reports obtained while in the power savings mode with the same weight as information reported by the user equipment when not in a power savings mode, or the SON function may need to adjust network parameters (e.g., mobility handover parameter values) in order to have, for example, an optimum mobility performance. For example, the SON function adaptation of parameters may be configured to have different (e.g., smaller) adjustment steps, when using information reported during a power savings mode.

In some example embodiments, immediate MDT reports and MDT logs may be marked by the user equipment with the current mobility information that the user equipment has derived, so that network is able to determine from the immediate and/or logged MDT logs whether the user equipment mobility was, for example, low or high. Alternatively, or in addition, the network (e.g., a node in the network, such as a base station, an OAM node, and the like) may include the mobility information (which is reported by the user equipment) in measurements for immediate MDT reports. In addition, the network may include its own knowledge (e.g., based on tracking the user equipment's mobility in connected mode) about the user equipment's mobility in any reported measurement results. The user equipment mobility indication may also be used in conjunction with information elements, such as the LocationInfo-r10 information element that can be attached to MDT logs (if user equipment has positioning information available). The LocationInfo-r10 information element may include the horizontal Velocity-r10 information element, which provides user equipment speed and direction of movement (e.g., a vector). By combining these two information elements, the network may evaluate the validity of the mobility information, and correlate of the mobility information and the horizontal velocity, being sent by the user equipment and used by the network. The network may also determine the success rate of the user equipment's reporting of the correct mobility indication.

With immediate MDT, the MDT reporting may be performed in the same manner as a typical measurement reporting process for radio resource management purposes but the additional assistance information (e.g., user equipment preference for power savings and/or mobility information) may be included in the measurement report as an additional information element. The network is, however, normally kept informed about the user equipment indication and therefore the user equipment's mode can be attached by the base station to the received MDT report prior to sending the MDT report to an O&M node, such as a Trace Collection Entity (TCE) in example implementations using 3GPP-based networks.

In some example embodiments, the user equipment may provide, during the transition from idle mode to radio resource control (RRC) connected, to the network assistance information including at least one of mobility information and an indication of a user equipment preference for power savings. Assistance information, such as mobility information and/or user preference for power savings, may also be added to access failure reporting by the user equipment (e.g., the user equipment indicates if it has had failed network access attempts prior the successful completion of the connection set-up) for determining the access failure reason. The assistance information may also be sent any time there is a change in the user equipment mode (e.g., when the user starts or stops actively using the user equipment). When that is the case, the user preference for power savings may be toggled between TRUE and FALSE.

In example embodiments associated with smart phone optimization, the operation and mode of the smart phone can affect the information/reports provided by the smart phone and thus the success of the adaptation function to reach optimum performance. If for example the smart phone indicates a preference for power savings options and the network has configured the connection parameters (e.g., the DRX parameters) for maximized power saving at the smart phone, the information reported to the network can be influenced by the power optimized configuration typically resulting in less frequent measurements and consequently delayed triggering of mobility events. In this example, there may be a difference between the configurations for power optimized user equipment/smart phone configurations and so-called “normal” modes of operation. Hence, if the operational mode of the user equipment/smart phone is not taken into account, there may be a possibility that MDT data post-processing and SON adaptation receive from the user equipment/smart phone less than ideal information/reports, which may lead to erroneous, non-optimum values for system parameters being adjusted by SON and/or MDT.

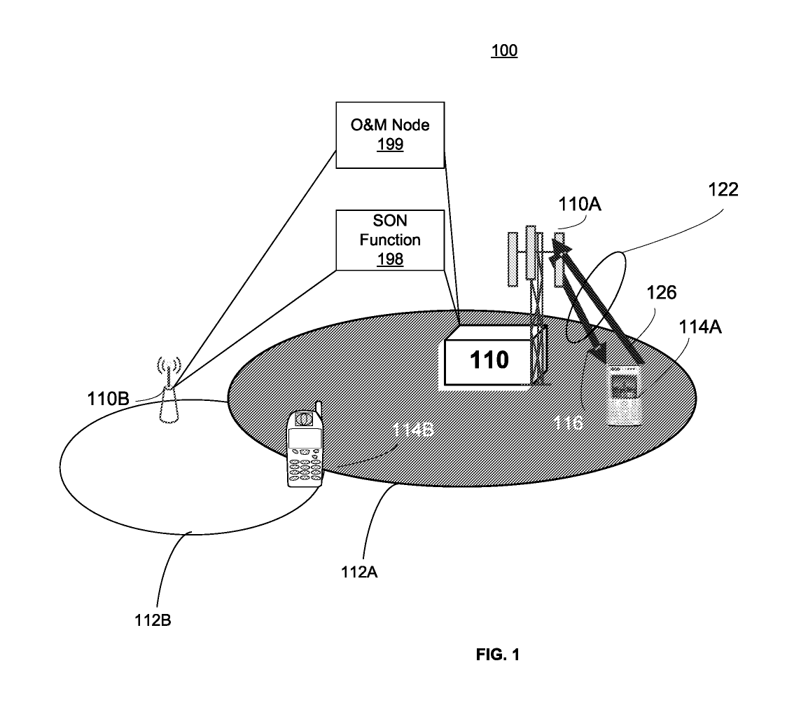

Before providing additional details, an exemplary system environment 100 is described in connection with FIG. 1. In some example embodiments, the wireless communication system 100 may include base stations 110A-B supporting corresponding service or coverage areas 112A-B (also referred to as cells). The base stations 110A-B may be capable of communicating with wireless devices, such as user equipment 114A-B, within its coverage areas.

Moreover, the base stations 110A-B may, in some example embodiments, be implemented as an evolved Node B (eNB) type base station consistent with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards).

Although FIG. 1 depicts an example of a configuration for base stations 110A-B, base stations 110A-B may be configured in other ways including, for example, relays, cellular base station transceiver subsystems, gateways, access points, radio frequency (RF) repeaters, frame repeaters, nodes, and include access to other networks as well. For example, base stations 110A-B may have wired and/or wireless backhaul links to other network elements, such as other base stations, a radio network controller, a core network, a serving gateway, an OAM node 199 (configured to provide at least MDT processing), a SON function 198, a mobility management entity, a serving GPRS (general packet radio service) support node, a network management system, and the like.

In some example embodiments, the user equipment 114A-B may have optimization features, such as for example smart phone optimization, to provide, for example, assistance information to the network. The user equipment 114A-B may be implemented as a mobile device and/or a stationary device. The user equipment 114A-B are often referred to as, for example, mobile stations, mobile units, subscriber stations, wireless terminals, tablets, smart phones, or the like. A user equipment may be implemented as, for example, a wireless handheld device, a wireless plug-in accessory, or the like. In some cases, user equipment may include a processor, a computer-readable storage medium (e.g., memory, storage, and the like), a radio access mechanism, and/or a user interface.

In some example embodiments, the wireless communication system 100 may include access links, such as links 122. The access links 122 include a downlink 116 for transmitting to the user equipment 114A and an uplink 126 for transmitting from user equipment 114A to the base station 110A. The downlink 116 may comprise a modulated radio frequency carrying information, such as RRC messages, location information, and the like, to the user equipment 114A, and the uplink 126 may comprise a modulated radio frequency carrying information, such as RRC messages, assistance information, location information, MDT reports, and the like, from the user equipment 114A to base station 110A. User equipment 114B may include links which are similar to (or different from) links 122.

The downlink 116 and uplink 126 may, in some example embodiments, each represent a radio frequency (RF) signal. The RF signal may, as noted above, include data, such as voice, video, images, Internet Protocol (IP) packets, control information, and any other type of information and/or messages. For example, when LTE is used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. The subject matter described herein is not limited to application to OFDMA systems, LTE, LTE-Advanced, or to the noted standards and specifications.

Although FIG. 1 depicts two base stations 110A-B, two cells 112A-B, and two user equipment 114A-B, a single O&M node 199, and a single SON function 198, the wireless communication system 100 may include other quantities of these devices as well.

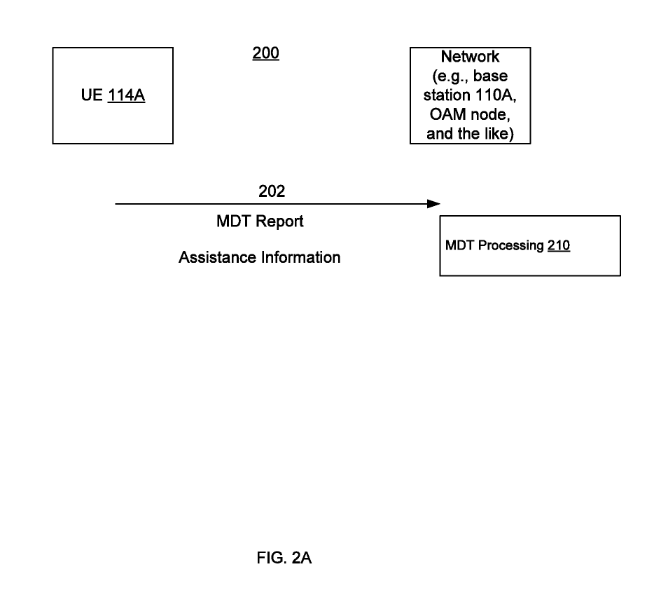

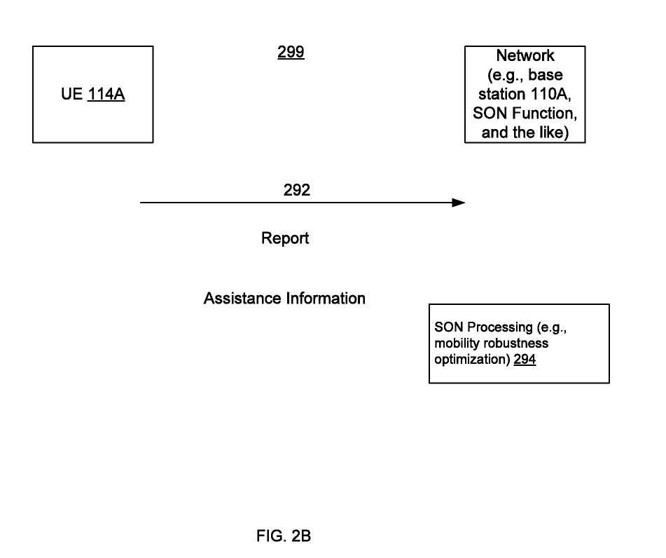

FIG. 2A depicts a process 200 for providing MDT reports and assistance information for use with MDT processing, in accordance with some example embodiments. The description of FIG. 2A also refers to FIG. 1.

At 202, the user equipment 114A may sends to the network, such as base station 110A, O&M node 199, and the like, an MDT report. The MDT report may include measurement results, such as radio measurement results for single or multiple cells or frequencies, information regarding failure events, location information (when available), and/or any other information. When user equipment 114A is configured to have smart phone optimization, the user equipment 114A may also provide assistance information, which may include mobility information and/or an indication of the user equipment's preference for power savings.

In some example embodiments, the mobility information and/or the indication of the user equipment's preference for power savings may be provided in a message sent by the user equipment to the network. An example of such a message is a radio resource connection (RRC) complete message, although the user equipment may send the mobility information and/or the indication to the network in other ways as well including, for example, using other types of RRC signaling messages, media access control messages (MAC) messages, and the like. Alternatively, or in addition to, signaling messages (and/or information elements) may be specified to specifically carry the mobility information and/or the indication of the user equipment's preference for power savings. Moreover, although the indication of the user equipment's preference for power savings is described as being sent with respect to an event, such as a connection set up or a connection release, the indication may be sent at other times as well (e.g., when the user stops actively using the terminal and thus only background traffic is generated by the user equipment or when the user starts actively using the terminal, or based on the reporting configuration from the network). The indication of the user equipment's preference for power savings may, as noted, be included as an additional information element in any suitable signaling message or information element.

At 210, the network may perform MDT processing based on information including the assistance information received at 202, in accordance with some example embodiments. For example, a node in the network, such as an O&M node 199, may perform MDT analysis based on the MDT report information including the mobility information of the user equipment and/or the indication of the user equipment preference for power savings. For example, this MDT processing may include detecting problematic coverage areas by collecting from one or more MDT reports radio measurement results, such as radio signal level, signal quality, failure reports, and the like. And, assistance information may be used to determine whether the mobility or power savings measures of the user equipment impacted the measurements. To illustrate further, a connection failure may be caused by infrequent measurements made when the user equipment is in a power savings mode or in a highly mobile state. To identify the cause of this failure scenario, the network/OAM node 199 may utilize the user equipment's assistance information to determine the root cause of the failure and whether the reported radio measurement results show the user equipment in a power savings mode or in a highly mobile state.

FIG. 2B depicts a process 299 for providing assistance information for use with a SON function, in accordance with some example embodiments. The description of FIG. 2B also refers to FIG. 1.

At 292, the user equipment 114A sends a report. to the network (e.g., a node, such as a base station 110A, a SON function node, and the like) The report may include information representative of a failure, such as a radio link failure, a hand over failure, and the like. When user equipment 114A is configured in accordance with smart phone optimization, the user equipment 114A may also provide assistance information, which may include mobility information and/or an indication of the user equipment's preference for power savings.

In some example embodiments, the mobility information and/or the indication of the user equipment's preference for power savings may be provided in a message sent by the user equipment to the network. Examples of such messages include a radio resource connection (RRC) complete message, other types of RRC signaling messages, MAC messages, specially configured messages/information elements for carrying the assistance information, and the like. Moreover, the assistance information sent by the user equipment to the network may be sent at connection set up, connection release, when the user starts or stops actively using the user equipment (e.g., when the user equipment is in a foreground or background traffic mode), and at other times as well.

At 294, the network performs SON processing taking into account the failure information provided by user equipment 114A as well as other information provided by other user equipment and nodes of the network. The SON processing may also be based on the assistance information received at 292. For example, a node performing a SON function may perform SON using information that includes the mobility information of the user equipment and/or the user equipment preference for power savings. In the case of SON, the SON processing may consider the impact of the user equipment's preference for power savings mode and/or the user equipment's mobility. By considering the user equipment's assistance information as reported by the user equipment/smart phone supporting such features, the SON function at 294 may treat the one or more reports received at 292 differently. For example, when adjusting mobility parameters, the SON function may make less of an adjustment to (e.g., increase, decrease, or disregard) a network parameter, when the user equipment is configured for power savings or when the user equipment is highly mobile.

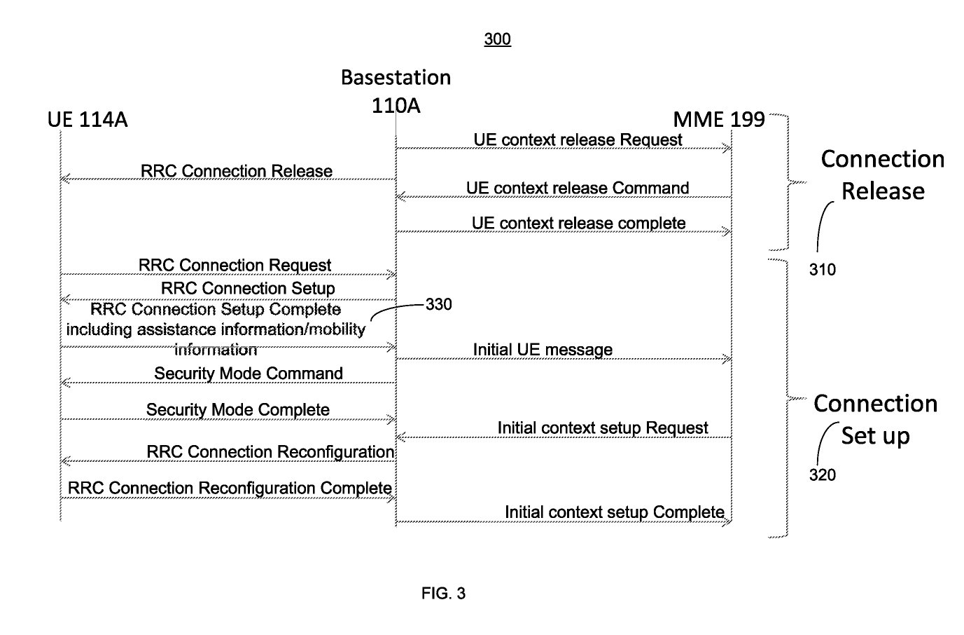

FIG. 3 depicts a process 300 for providing assistance information including at least one of mobility information and/or a user equipment preference for power savings at the user equipment, in accordance with some example embodiments.

At 310, a RRC connection release phase occurs, which is then followed by a RRC connection set up phase at 320. During the connection set up phase 320, the user equipment may send a plurality of messages to the user equipment. One or more of the messages may include assistance information including at least one of mobility information and/or a user equipment preference indication for power savings options at the user equipment. However, in the example of FIG. 3, the RRC connection complete message includes assistance information, such as mobility information of the user equipment and/or the user equipment preference indication for power savings.

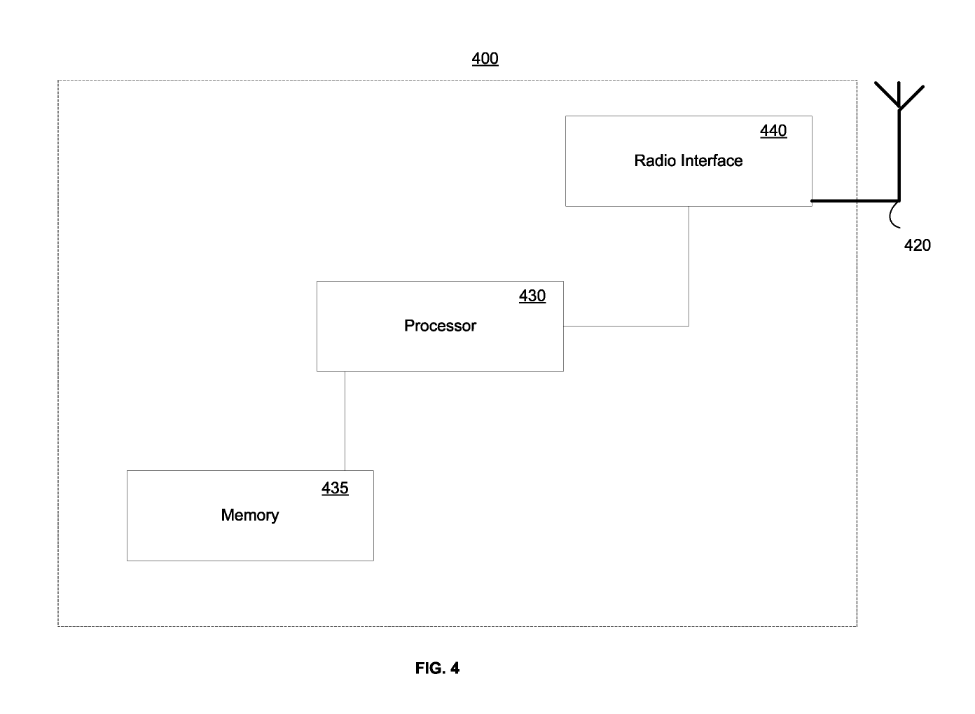

FIG. 4 depicts an example implementation of a base station 400, which may be implemented at base station 110A-B. The base station includes one or more antennas 420 configured to transmit via a downlink and configured to receive uplinks via the antenna(s) 420. The base station further includes a radio interface 440 coupled to the antenna 420, a processor 430 for controlling the base station 400 and for accessing and executing program code stored in memory 435. The radio interface 440 further includes other components, such as filters, converters (e.g., digital-to-analog converters and the like), mappers, a Fast Fourier Transform (FFT) module, and the like, to generate symbols for a transmission via one or more downlinks and to receive symbols (e.g., via an uplink). In some implementations, the base station is also compatible with IEEE 802.16, LTE, LTE-Advanced, and the like, and the RF signals of downlinks and uplinks are configured as an OFDMA signal. The processor 430 may access code in memory, which causes base station 400 to provide one or more of the operations described herein with respect to a base station. The base station 400 may also couple to (or include) at a SON function and/or an OAM node, each of which comprises at least one processor and at least one memory including code, which when executed by the at least one processor provides one or more aspects of the SON and/or MDT processing disclosed herein.

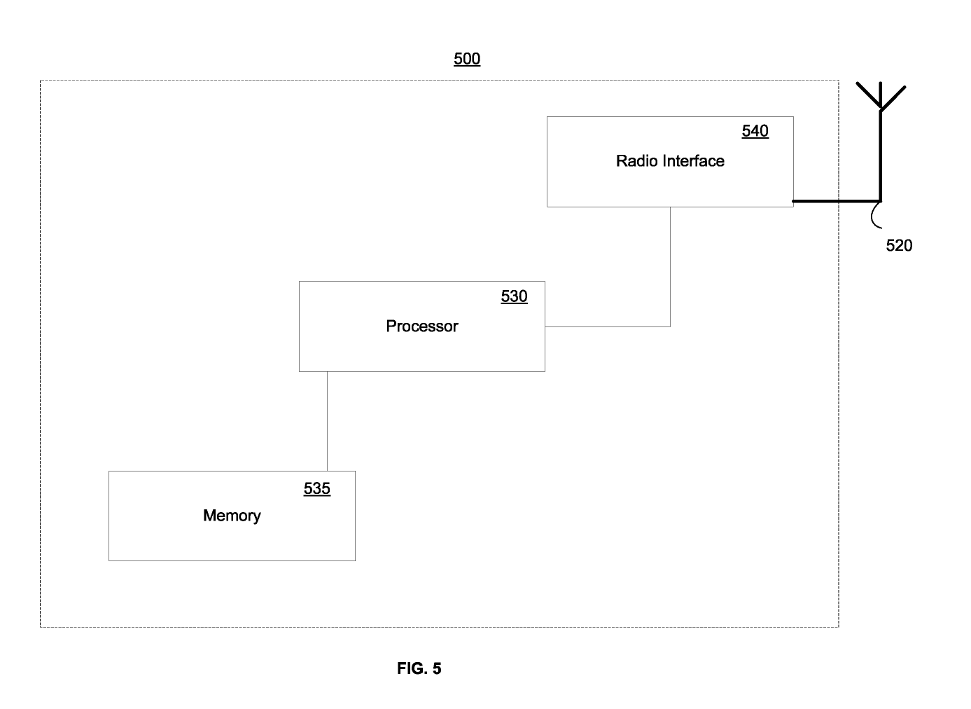

FIG. 5 depicts a block diagram of a radio, such as a user equipment 500. The user equipment 500 may have smart phone optimization features including one or more always-on applications. Moreover, the user equipment 500 may include an antenna 520 for receiving a downlink and transmitting via an uplink. The user equipment 500 may also includes a radio interface 540, which may include other components, such as filters, converters (e.g., digital-to-analog converters and the like), symbol demappers, signal shaping components, an Inverse Fast Fourier Transform (IFFT) module, and the like, to process symbols, such as OFDMA symbols, carried by a downlink or an uplink. In some implementations, the user equipment 500 may also be compatible with WiFi, Bluetooth, GERAN, UTRAN, E-UTRAN, and/or other standards and specifications as well. The user equipment 500 may further include at least one processor, such as processor 530, for controlling user equipment 500 and for accessing and executing program code stored in memory 535. The processor 530 may access code in memory, which causes user equipment 500 to provide one or more of the operations described herein with respect to the user equipment.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the examples described with respect to conformance testing (and the system simulator) may also be used in connection with MDT, and the examples described with respect to MDT may also be used with conformance testing (and the system simulator). Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-39. (canceled)

40. A method comprising:
sending, by a user equipment, a minimization of drive testing report to a network; and
sending, by the user equipment, assistance information to the network for a minimization of drive testing function at the network, wherein the assistance information includes at least one of a mobility information and a user equipment indication representative of a preference for power saving at the user equipment.

41. The method of claim 40, wherein the assistance information enables the minimization of drive testing function at the network to adapt based on whether at least one of a mobility state of the user equipment and a power savings mode of the user equipment.

42. The method of claim 40, wherein the minimization of drive testing report comprises at least one of a measurement information, a failure information, and a location information.

43. The method of claim 40, wherein at least one of the user equipment and the network associates a measurement result in the minimization of drive testing report with the assistance information.

44. The method of claim 40, wherein the assistance information and the minimization of drive test report are sent in a same message or different messages.

45. The method of claim 40, wherein the minimization of drive testing function validates a relevance of the assistance information including a mobility and a velocity reported by the network.

46. The method of claim 40, wherein the minimization of drive testing function at the network adapts information from the minimization of drive testing report based on the associated assistance information, wherein the adaption includes at least one of a removal of a portion of the information and an adjustment of a weight used to vary the portion of the information.

47. An apparatus comprising:
at least one processor; and
at least one memory including computer program code, the at least one memory and the computer program code configured to, with the at least one processor, cause the apparatus to at least:
send a minimization of drive testing report to a network; and
send assistance information to the network for a minimization of drive testing function at the network, wherein the assistance information includes at least one of a mobility information and a user equipment indication representative of a preference for power saving at the user equipment.

48. The apparatus of claim 47, wherein the assistance information enables the minimization of drive testing function at the network to adapt based on at least one of a mobility state of the apparatus and a power savings mode of the apparatus.

49. The apparatus of claim 47, wherein the minimization of drive testing report comprises at least one of a measurement information, a failure information, and a location information.

50. The apparatus of claim 47, wherein at least one of the apparatus and the network associates a measurement result in the minimization of drive testing report with the assistance information.

51. The apparatus of claim 47, wherein the assistance information and the minimization of drive test report are sent in a same message or different messages.

52. The apparatus of claim 47, wherein the minimization of drive testing function validates a relevance of the assistance information including a mobility and a velocity reported by the network.

53. The apparatus of claim 47, wherein the minimization of drive testing function at the network adapts information from the minimization of drive testing report based on the associated assistance information, wherein the adaption includes at least one of a removal of a portion of the information and an adjustment of a weight used to vary the portion of the information.

54. An apparatus comprising:
at least one processor; and
at least one memory including computer program code, the at least one memory and the computer program code configured to, with the at least one processor, cause the apparatus to at least:
send to a network including a self optimizer, a report including failure information; and
send assistance information to the network including the self optimizer, wherein the assistance information includes at least one of a mobility information and a user equipment indication representative of a preference for power saving at the user equipment.

55. The apparatus of claim 54, wherein the assistance information enables the self optimizer to adapt based on at least one of a mobility state of the apparatus and a power savings mode of the apparatus.

56. The apparatus of claim 54, wherein the failure information includes at least one of a radio link failure information and a handover failure information.

57. The apparatus of claim 54, wherein the self optimizer determines an adjustment to at least one network parameter based on the assistance information.

58. The apparatus of claim 54, wherein at least one of the apparatus and the network associates the report including the failure information with the assistance information.

59. The apparatus of claim 54, wherein the assistance information and the report are sent in a same message or different messages.
